(19) United States
(12) Patent Application Publication
(10) Pub. No.: US 2004/0063491 A1
(43) Pub. Date: Apr. 1, 2004

(54) Virtual ball selector

(76) Inventors: Frank B. Banyai, Las Vegas, NV (US); Kevin J. Burman, Sydney (AU)

Correspondence Address: Marvin H. Kleinberg, Esq., Suite 1080, 2049 Century Park East, Los Angeles, CA, 90067, US

(21) Appl. No.: 10/256,717

(22) Filed: Sep. 27, 2002

(51) Int. Cl. G06F 17/00

(52) U.S. Cl. 463/22

(57) ABSTRACT

Both a computer based means and method for achieving a random ordering of objects by emulating a mechanical air blower device and an electronic device that accurately emulates a mechanical device used to mix light-weight balls are shown. In the preferred embodiment, the device is used to select winning numbers for games such as Bingo or KENO.

### BACKGROUND

1. Field of the Invention

The present invention relates generally to the field of gaming equipment, and more specifically to a virtual ball mixing system that allows virtual balls having numerical or graphical representations thereon, to be chosen in a random manner that accurately emulates the methods used in prior art mechanical pneumatic devices.

2. Prior Art

Games such as Keno and Bingo are well known in prior art. These games typically include lightweight balls, such as table tennis balls, which are imprinted with numbers and/or letters. Because the balls are lightweight, they can be mixed in an enclosed space by one or more jets of air and selected from the mix through various means. The ball selections can be used in several ways, depending upon the rules of the game being played. In one variation of the game, the game ends when a pre-determined number of balls have been “drawn”. The numbers and/or symbols on the selected balls are used by players manually (subject to verification) or automatically, to determine whether they are a “winner” of the game. The game may have a winner if, before the draw, someone selected the winning numbers, as in state lottery games.

Although the prior art mechanical devices work, they are not without problems. For example, they are labor intensive. They are also subject to fraudulent abuse by virtue of the fact that they require human handlers to retrieve and announce the selected balls. More important, they are relatively slow to reach a result, limiting the number of games that can be completed in an hour and, as a consequence, limiting the potential revenue stream.

As discussed in U.S. Pat. No. 5,380,007 (Travis), mechanical devices to mix balls through jets of air are noisy and relatively expensive to maintain. Prior art electronic devices, such as described in the '007 patent, overcome these problems, but do not truly emulate the mechanical apparatus. Instead, they use pseudo-random number generators to select the “winning” balls and fail to truly emulate the action of the mechanical device because they do not use environmental factors, such as collisions, when calculating ball movement.

For example, the '007 patent uses random number generators to select the winning balls and the motion calculations simply display graphics that represent the motion of balls moving in an enclosed area. However, it does not use the motion calculations to emulate the action of mixing the balls by using one or more air streams.

Thus, the prior art sometimes uses graphics software to replicate the visual imagery of a pneumatic-mechanical ball blowing device that mixes balls by using one or more jets of air in cooperation with the random collisions that result from such motion. However, they do not emulate the physical interaction of the balls and the jets of air to affect the outcome.

### BRIEF DESCRIPTION OF THE INVENTION

According to the present invention, an electronic device is programmed to accurately emulate a pneumatic-mechanical device such as is used to mix relatively lightweight balls that are situated in a confined space. The program emulates the use of jets of air directed at the balls to randomly mix the balls through an emulation of the collisions of the balls with each other or the walls of the mixing chamber. In the preferred embodiment, the device may be used for games including, but not limited to, Lottery, Poker, Bingo or KENO.

In the mechanical apparatus of the prior art, balls are introduced into a three-dimensional chamber. One or more jets of air flow into the chamber to cause the balls to move and to collide with each other. As the balls collide, they are mixed in a random orientation. Ultimately, one or more balls are selected and withdrawn from the mixing chamber. The numbers and/or symbols on the selected balls are used by players, manually (subject to verification) or automatically, to determine whether they are the “winner” of the game.

The present invention creates a series of virtual objects stored in computer memory. These virtual objects have attributes associated with them, patterned after the actual physical properties of the object being emulated, that include a circular shape, dimensions in at least two directions, size, graphics, mass, etc. The objects are introduced into a virtual mixing chamber, either en masse or sequentially. In the preferred embodiment of the present invention, the virtual mixing chamber has height and width dimensions and has a depth dimension that is sufficiently small to prevent balls from being obscured one by another. The invention also has a method for viewing and recording of the ball mixing process. This provides a defense against fraudulent manipulation of results that was possible with other prior art devices.

One or more simulated air jets are used to mix the balls. The air jet(s) may be started before, while, or after the balls are introduced into the virtual mixing chamber chamber. As the balls encounter the air flow, the balls move generally in the direction of the air jet as influenced by the simulated effect of gravitational force. Various factors determine the direction and speed at which the ball travels through the virtual mixing chamber.

If a ball collides with another ball or with the boundary of the virtual mixing chamber, the combined forces of the collision, the air jet factors and the simulated effect of gravitational force produce a new vector of travel for each of the balls involved in the collision. As a ball moves closer or further away from the center of the air jet(s), it travels in a different vector.

When the balls are sufficiently mixed, one or more balls are allowed or caused to escape the chamber. These escaped balls represent the numbers and/or symbols that are used as prescribed by the rules of each game including but not limited to determining whether there has been a winning player or winning combination of numbers and/or symbols.

The duration of each game can be selected by the appropriate choice of factors such as the number of collisions in the mixing phase or simply the passage of time.

It is therefore an object of the present invention to provide a device that electronically replicates the ball blowing apparatus used to mix and select balls in a gaming system.

It is a further object of the present invention to create a documentary record of the results of the ball blowing apparatus used to mix and retrieve balls in a gaming environment.

Further features and advantages of the present invention will be appreciated by reviewing the following drawings and detailed description of the invention.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a flow chart describing the basic procedures of the virtual ball selection mechanism of the present invention;

FIG. 2 is a plan view of a virtual machine at the initial state of the system, with the virtual balls stored in a loading hopper;

FIG. 3 is a plan view of the mixing state of the system, with the virtual balls being mixed in the mixing chamber;

FIG. 4 is a plan view of the final state of the system, with the virtual balls being selected and placed in the display tray; and

FIG. 5 is a graphical representation of a system wherein the computer and game are geographically proximate, according to one embodiment of the invention; and

FIG. 6 is a graphical representation of a system wherein the computer and game are geographically remote, according to one embodiment of the invention.

### DETAILED DESCRIPTION OF THE INVENTION

A novel method and apparatus for emulating the mixing of objects, such as lightweight balls, with virtual air streams will now be described. In the following description, for the purposes of explanation, specific component arrangements and constructions and other details are set forth in order to provide a more thorough understanding of the present invention. It will be apparent to those skilled in the art, however, that the present invention may be practiced without these specific details. In other instances, well known manufacturing methods and structures have not been described in detail so as not to obscure the present invention unnecessarily.

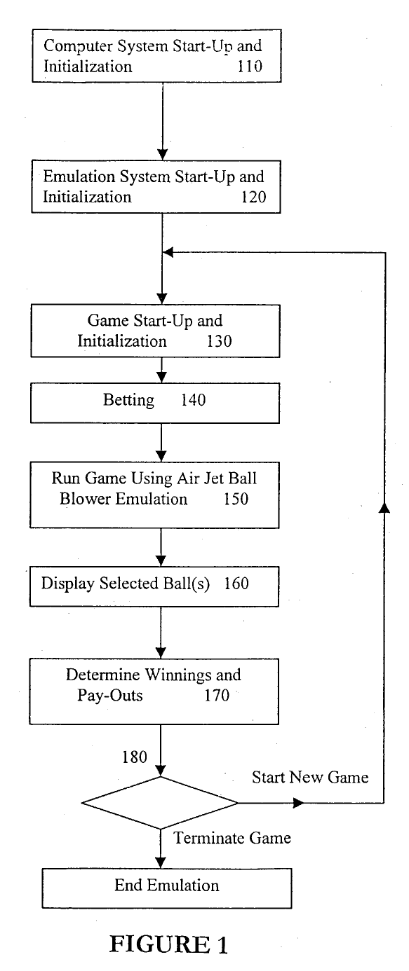

Referring first to FIG. 1, a flow chart describes the basic steps of the virtual ball selection emulation system.

1) In a first step 110, the computer system is initialized.

2) The next step is the emulation start-up and initialization step 120. This step includes choosing numbers or symbols on a card, cards or electronic device, to match with the balls drawn.

3) Next is the game start-up and initialization step 130. This step includes starting any audio-visual effects and initializing the starting sequence of the balls. Some randomness can be introduced into the initial starting sequence of the balls to introduce a change in the environment variables of the system;

4) A participatory or betting phase is the next step 140 in which the player supplies money (using coins, currency or a credit transaction) to the machine and selects (or is provided with) one or more combinations of symbols.

5) A “mixing” step 150, introduces the virtual balls into the virtual mixing chamber. A virtual air jet impinges upon the balls to achieve a random order that emulates the actual effects of a pneumatic mechanical device. Several different environment modifications can add more randomness to the process, such as changing pressure and direction in the air jet(s) and varying the mixing time.

6) The step of selecting a winner 160 occurs after the balls are sufficiently mixed. This is generally done by each virtual ball escaping from the virtual mixing chamber when it becomes sufficiently close to a “suction” inlet which transfers the selected balls to a display device. The balls that are displayed determine the winning numbers, letters or other symbols.

7) The final step of play 170 scores the game and pays any winnings as are necessary.

8) A decision point 180 gives the options of either starting a new game or ending the emulation.

Steps 4-6 specifically use the virtual ball selector invention to randomize the ball selection process and are, therefore, reasonably uniform regardless of use. Steps 3 and 8 could vary for each type of game wherein the invention is used, so there are potentially many different examples of these steps. Also, note that steps 4-7 can be repeated several times during a game. For example in bingo, the selecting step 160 (step 6) normally involves capturing a single ball. The final game step 170 involves players marking their cards and potentially calling bingo in the BINGO game embodiment. Until the game is ended by a player achieving a winning combination, the system returns to the mixing step 150 for further mixing of the remaining balls, and the selecting step 160 to capture another ball and so on.

For use in other games, the system may perform these steps in a similar, but slightly different, manner, depending upon the rules of each particular game.

[System initialization] The invention described herein is a computer-based method and means to achieve a random result by mixing a series of objects by emulating the mechanical, pneumatic air blower device used in prior art. Because the system of the present invention is computer based, the first step in the method of the invention is system initialization 110. If the system involves a wide area network, the system must initiate these steps for each remote site linked to the network.

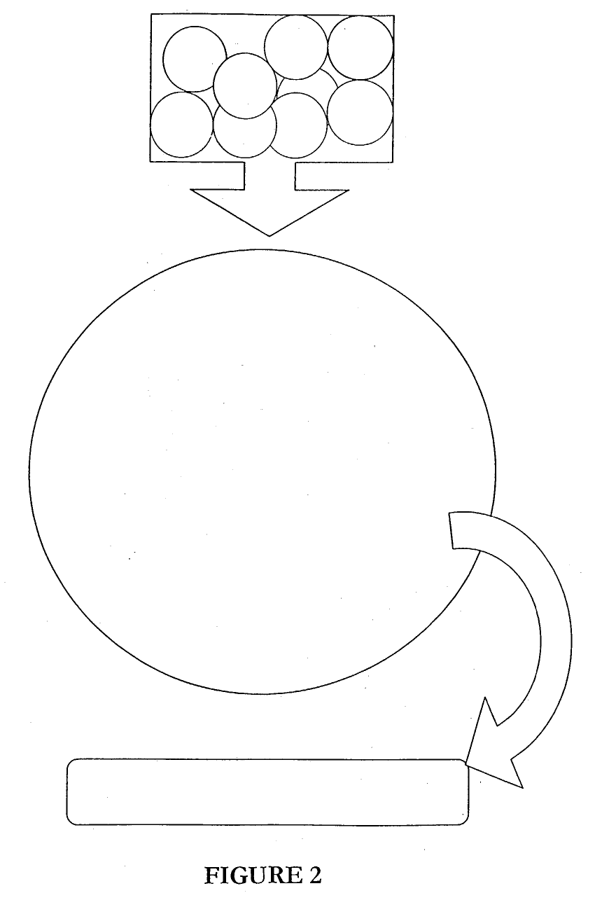

The next step in the process is emulation start-up and initialization step 120. This second step includes initialization of the data objects used in the application program, such as a game environment. This requires assigning attributes to the virtual objects represented in the emulation and distributing playing cards or markers for the game that is using the system in the event that the game being played is a game of chance. As shown in FIGS. 2-5, the virtual apparatus used in the invention includes a holding chamber 10 in which the balls are initially placed. The holding chamber 10 is coupled to a mixing chamber 20. The mixing chamber 20, which incorporates an air stream 22 having an outlet through which air is passed into the mixing chamber 20, is coupled to a ball retrieval system that includes a vacuum inlet 24 to draw balls from the mixing chamber 20 into a tray, pipe or other display receptacle 30 in which the selected balls 12 come to rest. The display receptacle 30 displays the numbers or symbols on the selected balls 12, which represent the winning combination of numbers or symbols.

In a gaming environment, one of the first steps in the game after game start-up and initialization 130 but prior to the mixing step 150 is to place a bet. Thus, the first step in the gaming process 140, as implemented in the preferred embodiment, is to make a wager. This may be accomplished through a coin or currency collection mechanism or through a credit system in which the player establishes a credit line (either though the use of credit cards or through a predetermined arrangement with the operator which provides a line of credit). Because the present invention uses a computer, the credit balance may be maintained in the computer.

As noted, in the present invention the entire process is performed through computer emulation. Thus, the balls 12 used by the present invention are virtual balls which are simulated within a computer to have the physical attributes of real balls. The mixing chamber as well as the other seemingly physical devices and objects of the system are also emulated in the computer, as described below.

[Mixing Process]

The mixing step 150 begins with the transfer from the hopper 10 of the virtual balls 12 into a virtual mixing chamber 20. Each virtual ball 12 is, in fact, nothing more than a data item or object in a computer system. The normal attributes of a ball, as used in a mechanical gaming system, are assigned to each virtual ball. These attributes include the location of the object within the virtual mixing chamber 20, the intake holding area of hopper 10, the dimensions of the display device 30, and information associated with the object, such as size, mass, color and/or numerical and/or graphical design properties. During the mixing process, other attributes are established, such as initial speed or velocity and direction of travel (vector).

The virtual mixing chamber 20 is also a data item in the computer system and also has properties associated with it. These properties include size, shape, air intake and outlet location(s) and a ball retrieval and introduction system. The air jet 22 is also a data item within the computer and has properties that include volume of flow, direction of flow, force of flow, etc.

Randomness factors can be introduced into each of these variables so that the values for each attribute vary during the mixing process. By way of example, the volume of flow can change an arbitrary number of times and within a randomly chosen variable limit during the course of the game. Likewise, the direction, duration and force of air flow can also vary during the mixing process. Other variables that can affect the positioning of the balls include a “starting point”, the mass of each ball, the gravitational force, an initial direction and a (horizontal) width. Some of these variables can be varied throughout the course of the game, and others can be varied from game to game, to increase the randomness of the final result of each game.

In an actual air stream, the air is fastest in the center and slows towards the edges. The width of the jet defines the point at which the air stream no longer has any influence. However, the higher velocity of the center of the stream creates a “low pressure” area which, in the physical world, tends-to keep a ball centered in the air column. In much the same manner, the (vertical) length of the air jet 22 affects the results. The air is fastest at its ‘starting point’ (bottom) and moves increasingly slower as it moves away from the starting point. The force of the air jet 22 (vector length) extends from the starting point to the point at which the air stream no longer has any influence on the balls. Finally, the maximum velocity is the speed of the air at its starting point. The speed at all other locations is scaled down from this maximum velocity.

Now referring to FIG. 2, as noted above, a game begins when the virtual balls 12 are introduced from the intake holding area 10, sequentially or en masse into the virtual mixing chamber 20, i.e. the virtual ball's location properties are modified as it is introduced into the game, to identify it as being within the virtual chamber 20. In the preferred embodiment, numbers and/or symbols are randomly assigned to each virtual ball 12 immediately before its introduction into the virtual mixing chamber 20.

Also in the preferred embodiment, a virtual air jet 22 is initiated within virtual the mixing chamber 20 to start the mixing process after all of the virtual balls 12 are in the virtual mixing chamber 20. In another embodiment, the virtual balls 12 are sequentially introduced into the mixing chamber 20 after the air jet 22 has started. In the latter embodiment, the virtual balls 12 are immediately affected by the air jet(s) 22 upon introduction into the mixing chamber 20.

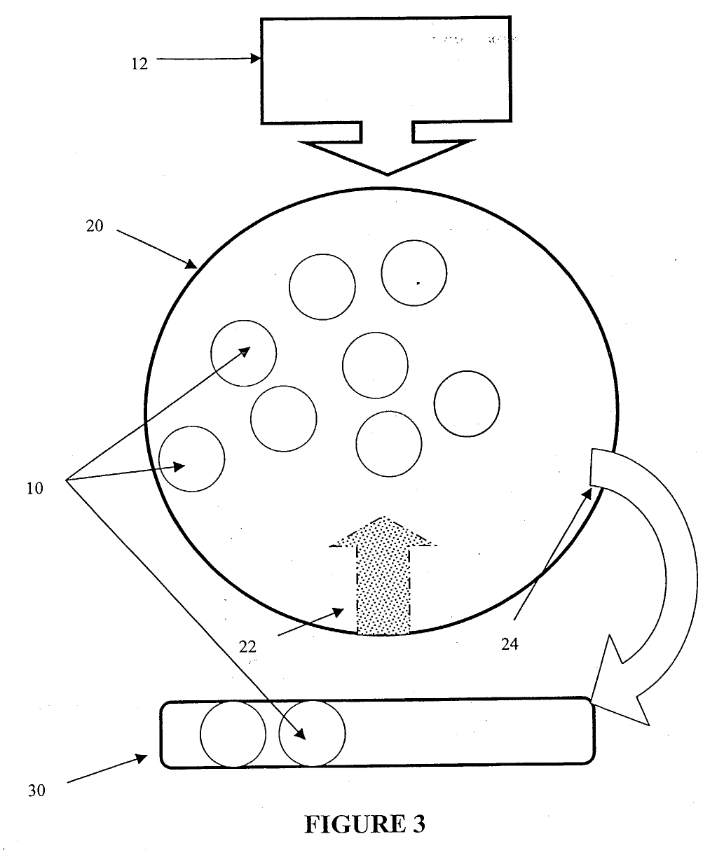

Now referring also to FIG. 3, in any embodiment, the mixing process has certain characteristics. First, the system must determine the time “tₛₑ” at which the next “significant event” will occur, based on the positions and velocities of all objects in the system. A significant event is one of:

a) A collision between two balls or between a ball and a wall of the mixing chamber;

b) External forces acting on the balls with the external forces including gravity and the air stream. The forces are applied at discrete intervals that are sufficiently small to emulate real-time mixing action;

c) Rendering a frame of the animation for analysis and data manipulation, i.e. applying the various environmental variables to each virtual ball 12 at each interval and calculating the next location of each virtual ball 12.

Next, the system advances to the next time “tₛₑ” by independently moving each object at its current velocity and duration for a discrete time period. This produces new positions for all objects. If the next significant event that happens at time “tₛₑ” is a collision, i. e. one or more vectors intersect or a vector length would take it beyond the boundaries of the virtual mixing chamber 20, the collision is processed. This produces new velocities for the objects involved in the collision. If the significant event that happens at time “tₛₑ” is “rendering a frame of the animation”, the frame is prepared. This step has no effect on any objects in the system. Finally, external forces are applied to each virtual ball 12 at its new position. Each force is independently applied to each object, producing new velocities and vectors for all objects.

The virtual air jet 22 is located at the base of the virtual chamber 20 and causes the virtual balls 12 to be elevated from the floor of the virtual chamber 20. In the preferred embodiment of the present invention, there is only one virtual air jet 22. However, this is not a limiting factor of the invention. While all of the virtual balls 12 are elevated from the chamber 20 floor by the introduction of the stream of air from the air jet 22, each virtual ball 12 travels on a different vector and to a different location within the mixing chamber 20. The ultimate location of the ball 12 will be based upon its starting point and its direction and distance from the center of the air jet 22. The force of the air jet 22 upon each ball takes the ball to a different location within the mixing chamber 20. As the virtual balls 10 collide with each other and/or the boundaries of the virtual mixing chamber, each virtual ball changes direction and velocity, further randomizing the mix.

As was noted above, altering the environment of the virtual mixing chamber 20 can change the results of the mixing process. In alternative embodiments of the invention, varying the direction of the air jet 22, the force of the air jet 22 and the duration of the mixing time further randomize the mix. Each such modification within the environment of the virtual mixing chamber 20 produces variations in the results of the mixing process and assists in assuring a truly random result.

[The Retrieval Process]

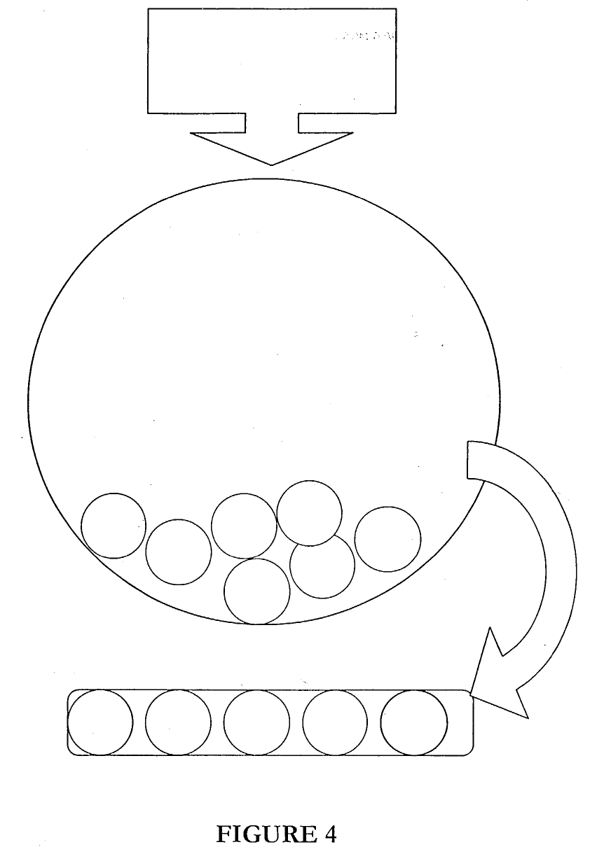

Referring next also to FIG. 4, the next step of the mixing process is the ball selection and retrieval step 160 wherein a virtual ball 12 is retrieved from the virtual mixing chamber 20 to provide a winning number or symbol or a portion thereof. In the preferred embodiment, a virtual door 24 will open in the virtual mixing chamber 20 (while the air stream is still agitating the balls) and the system will wait for a virtual ball 12 to pass sufficiently close to the door 24 for the ball 12 to be “sucked out” of the mixing chamber 20 and into the retrieval tube or other display receptacle 30.

The door 24 could be located somewhere around the edge of the virtual mixing chamber 20 or it could be located within the virtual mixing chamber 20 (allowing a ball to exit the virtual mixing chamber 20 via the normally restricted 3rd dimension). If just one ball 12 is required, the door 24 will close as soon as the first ball 12 has exited the virtual mixing chamber 20. If more than one ball 12 is needed, the door 24 will remain open until the appropriate number of balls 12 has been sucked out of the virtual mixing chamber 20.

Alternatively, the balls can be allowed to come to rest at the bottom of the mixing chamber by switching off the air supply, and a ball can be selected by a simulated mechanical picking device such as is seen in prior art.

In an alternative embodiment, inserting an additional random delay before opening the door 24 varies the environment of the retrieval process. This is not strictly necessary if the selection process is triggered automatically, but it may be important if a human operator triggers the selection process.

When a virtual ball 12 has been removed from the virtual mixing chamber 20, it is placed into a retrieval tube or other display receptacle 30. The retrieved balls 12, with identifying indicia, are displayed in the display device 3.

[Paying Out Winnings]

The final step of actual play 170 is to determine if there are any winners and, if there are, determining the amount of any winnings for the game. This is done by comparing the indicia of the retrieved balls with the selections made by the player or otherwise at the outset of the game. The comparison may be performed manually by the player (by daubing or otherwise marking the cards) or automatically by the computer system or individual input device. If a player has selected the combination that is displayed in the display device, or, according to the rules of the game, is eligible for a prize, than a prize may be claimed by the player or a winner is announced and the winnings can be either disbursed in coins and/or currency or credited to account of the player.

At the decision step 180, a new game can be started immediately thereafter, following the steps as outlined above or the program can be terminated.

[Networking]

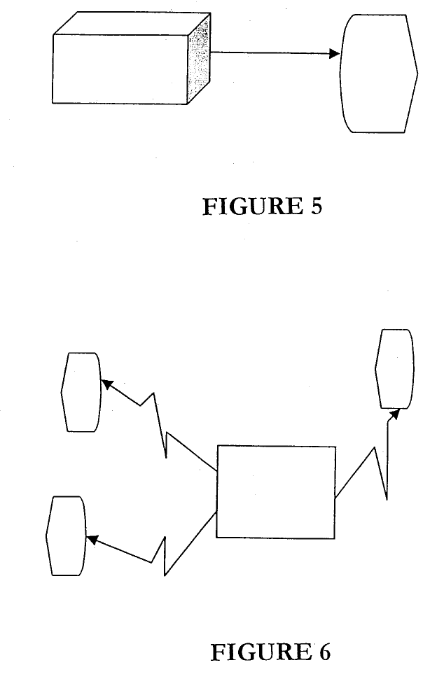

As seen in FIGS. 5 and 6, in the preferred embodiment of the invention, the virtual ball blowing machine is located at one node of a network. The remaining nodes have input and output devices attached to the network. Input devices allow users to receive playing cards and place wagers on the game. Output devices allow users to watch the game as it is being played and the results at the conclusion of the game. In an alternative embodiment, the machine is used in a non-networking mode whereby the input and the output devices are physically located in close proximity to each other and the machine may be in close proximity or in a remote location.

[Hardware/Apparatus Description]

The invention has several possible hardware configurations and implementation details will be familiar to those skilled in computer network systems. In one configuration, as shown in FIG. 5, the invention is used for gaming at a central facility, such as the traditional “Bingo Hall” which uses the mechanical version of the ball selection mechanism. This embodiment of the invention requires at least the virtual ball blower and a display device such as a large screen, a voice annunciation unit or printed output. In another embodiment, as shown in FIG. 6, the virtual ball blower is located at one location and one or more output devices are located at another site. For example, the computer which generates the virtual ball blower may be located in an office while one or more output display devices are located in one or more gaming halls.

In another embodiment, the computer generating the virtual ball blower is again located in a central location and one or more output display devices are located in multiple gaming halls. In another embodiment, the computer generating the virtual ball blower is located in a central location and the satellite nodes are individual gaming stations geographically separated from the virtual ball blower and from each other.

The description of the present invention has been made with respect to specific arrangements and constructions of a computer based method for mixing a series of objects by emulating a mechanical air blower device used in prior art. It will be apparent to those skilled in the art that the foregoing description is for illustrative purposes only, and that various changes and modifications can be made to the present invention without departing from the overall spirit and scope of the present invention. The full extent of the present invention is defined and limited only by the following claims.

What is claimed is:

1. A method for computer emulation of an air jet driven ball blowing machine, comprising the steps of:
initializing a computer system, including the steps of:
running standard computer start-up programs;
creating data objects for use as virtual objects within said computer emulation;
assigning properties to said data objects allowing said data objects to be associated with the physical properties of objects being represented by said emulation, including virtual balls, virtual air jets and virtual containers;
mixing said virtual ball data objects including the steps of;
assigning a random order to a plurality of virtual ball data objects having the property of balls at rest in an intake chamber;
introducing said plurality of virtual ball data objects into a virtual mixing chamber data object having a virtual boundary/perimeter, a virtual air jet outlet data object, a virtual air jet inlet data object and a virtual ball intake mechanism data object;
initiating calculations for said virtual air jet in said virtual chamber;
performing calculations on each of said virtual balls to determine the effect of said virtual air jet on each said virtual ball;
re-calculating the location of each said virtual ball within said virtual mixing chamber, based upon said calculations performed on said virtual ball;
selecting at least one of said virtual balls; and
placing said selected virtual ball(s) into a virtual display chamber.

2. The method of claim 1 further wherein said virtual air jet has properties that include force, width, direction and flow angle.

3. The method of claim 2 further wherein said angle of said virtual air jet randomly varies during said mixing process.

4. The method of claim 2 further wherein said force of said virtual air jet randomly varies during said mixing process.

5. The method of claim 1 further wherein said virtual air jet includes a plurality of individual virtual jets.

6. The method of claim 1 further wherein the duration of said mixing step randomly varies each time the step is practiced.

7. The method of claim 1 further wherein said plurality of virtual balls is placed into said virtual retrieving chamber one virtual ball at a time.

8. The method of claim 1 wherein the time during said mixing process between when any two said virtual balls is retrieved is randomly varied.

9. Means for emulating a mechanical air jet driven mixing device, comprising:
a computer;
an input device coupled to said computer;
an output device coupled to said computer;
a memory storage device coupled to said computer; and
means within said computer to mathematically compute the interaction of objects within a mechanical air jet mixing device, including;
a virtual mixing chamber;
a virtual air jet coupled to said virtual mixing chamber;
virtual balls capable of being affected by said virtual air jet, virtual gravity and virtual collisions with others of said virtual balls;
a virtual hopper to store said virtual balls prior to starting a virtual mixing process; and
a virtual display area to display the selected ones of said virtual balls after said virtual mixing process;
said computer being programmed to perform calculations to change the virtual direction and virtual speed of each of said virtual balls after they are introduced into said virtual mixing chamber and collide with each other and/or with the virtual walls of said virtual mixing chamber;
a selection process to retrieve selected ones of said virtual balls from said virtual mixing chamber for display in said virtual display area;
wherein virtual balls introduced into a virtual mixing chamber are virtually mixed by a virtual air stream and then retrieved to achieve a selection of said virtual balls for display.

10. The invention of claim 9 further wherein said virtual air jet has properties that include force, width, direction and angle.

11. The invention of claim 10 further wherein said angle of said virtual air jet randomly varies during said mixing process.

12. The invention of claim 10 further wherein said strength of said virtual air jet randomly varies during said mixing process.

13. The invention of claim 9 wherein said virtual air jet comprises a plurality of individual virtual jets.

14. The invention of claim 9 further wherein the duration of time used for said mixing process arbitrarily varies from one said mixing process to the next said mixing process.

15. The invention of claim 9 further wherein each virtual ball of said plurality of virtual balls is associated with a unique identifier and placed into said virtual retrieving chamber one at a time.

16. The invention of claim 9 further wherein the duration of time during said mixing process between the retrieval of any two said plurality of virtual balls is randomly varied.

17. The invention of claim 9 wherein said output device is physically located at a site that is remote from said computer.

18. The invention of claim 9 wherein said output device is physically located at a site that is close to said computer.

19. A method for the computer emulation of mixing of objects using an air jet, comprising the steps of emulating:
the introduction of objects into a holding area;
the transfer of said objects from said holding area into a mixing chamber;
the application of an air stream to impinge upon said objects in said mixing chamber;
the calculation of the interaction among said objects, said air stream and gravity within the confines of said mixing chamber; and
the retrieval of at least one of said objects from said mixing chamber after a pre-determined signal event.

20. The method of claim 19 also further including the step of emulating the display of said retrieved objects.

21. The method of claim 19 whereby said virtual objects are assigned attributes associated with the physical properties of ping pong balls.

22. Apparatus to achieve a random ordering of numbers through the computer emulation of an air stream mixing lightweight objects within a mixing chamber, comprising:
computer means to create virtual lightweight objects, a virtual mixing chamber, virtual holding areas and a virtual air stream;
means to associate properties with each of said virtual objects, virtual mixing chamber, virtual holding areas and a virtual air stream;
means to associate a unique number with each of said virtual objects;
means for introducing said virtual objects into the virtual confined space of said virtual mixing chamber;
means for introducing said virtual air stream into said virtual chamber to create interaction among said virtual objects and said virtual mixing chamber;
means for calculating the impact of said virtual air stream on said virtual objects within said virtual chamber; and
means for retrieving and displaying at least one of said virtual objects at the conclusion of said calculations on said object.
